(19) United States
(12) Patent Application Publication
(10) Pub. No.: US 2018/0039454 A1
(43) Pub. Date: Feb. 8, 2018

(54) INFORMATION PROCESSING APPARATUS AND METHOD OF CONTROLLING INFORMATION PROCESSING APPARATUS

(71) Applicant: SEIKO EPSON CORPORATION, Tokyo (JP)

(72) Inventor: Yuji SAITO, Matsumoto-Shi (JP)

(73) Assignee: SEIKO EPSON CORPORATION, Tokyo (JP)

(21) Appl. No.: 15/668,239

(22) Filed: Aug. 3, 2017

(30) Foreign Application Priority Data
Aug. 4, 2016 (JP) 2016-153453

(51) Int. Cl. G06F 3/12; H04L 29/08; G06F 13/10

(52) U.S. Cl. CPC G06F 3/1204; G06F 3/1215; G06F 3/1207; G06F 13/102; H04L 69/329

(57) ABSTRACT

A printer includes a control section that monitors the communication state of the communication with a host device via any one of a plurality of communication interfaces. When a communication connection between a host device, which is a processing target, and a predetermined communication interface is broken and then reconnected, the control section performs the following processing. The control section determines whether or not the host device, which is a communication destination of the predetermined communication interface, before the communication is broken is identical to the host device after the communication is reconnected. If determined to be identical, the control section 30 holds the data stored in a reception buffer corresponding to the predetermined communication interface. On the other hand, if determined not to be identical, the control section deletes the data stored in a reception buffer corresponding to the predetermined communication interface.

### BACKGROUND

### 1. Technical Field

The present invention relates to an information processing apparatus and a method of controlling an information processing apparatus.

An information processing apparatus is disclosed (for example, refer to JP-A-2010-3175) in which when wireless communication between a mobile terminal and an information processing apparatus (image processing apparatus) is broken and then reconnected, a determination is made as to whether or not the reconnected destination is identical device to the mobile terminal before the suspension, and if determined to be identical, data retransmission is requested from the mobile terminal. In JP-A-2010-3175, the information processing apparatus is capable of communicating with a mobile terminal using short-distance wireless communication by Bluetooth (registered trademark) and determines whether or not the mobile terminal is identical to the reconnected destination device using the telephone number of the mobile terminal. If determined to be identical, the information processing apparatus displays a PIN code for restarting a suspended job and requests retransmission of data when the PIN code is input from the user of the mobile terminal.

### 2. Related Art

Here, regarding information processing apparatuses that communicate with external devices, information processing apparatuses including a plurality of communication interfaces are in widespread use. In JP-A-2010-3175 described above, there is no disclosure regarding the point that the information processing apparatus that efficiently performs communication using a configuration including a plurality of communication interfaces, and thus there is room for improvement of this point.

### SUMMARY

An advantage of some aspects of the invention is that communication is efficiently performed using a configuration including a plurality of communication interfaces.

According to an aspect of the invention, there is provided an information processing apparatus including a plurality of communication interfaces capable of communicating with respective external devices, the information processing apparatus including: reception buffers that correspond to the respective communication interfaces and store data received from the respective external devices; and a control section that monitors communication states with the external devices and performs control in accordance with monitoring results, wherein while data is being received from one of the external devices via a corresponding one of the predetermined communication interfaces, if communication between the one of the external devices and the corresponding predetermined communication interface is broken and then reconnected, the control section determines whether or not the one of the external devices, which is a communication destination of the predetermined communication interface, before the communication is broken, is identical to one of the external devices after the communication is reconnected, and if determined to be identical, the control section holds data stored in a reception buffer corresponding to the predetermined communication interface, whereas if determined not to be identical, the control section deletes data stored in a reception buffer corresponding to the predetermined communication interface.

The information processing apparatus described above may further include a processing execution section that executes processing on the basis of data stored in the reception buffer of a processing target, wherein if the reception buffer corresponding to the communication interface with which the communication of the external device is broken is not the processing target of the processing execution section, the control section may delete the data stored in the reception buffer.

In the information processing apparatus described above, when data is being received from one of the external devices via a corresponding one of the predetermined communication interfaces, if communication between the one of the external devices and the corresponding predetermined communication interface is broken and then reconnected, if an amount of data stored in the reception buffer corresponding to the predetermined communication interface is smaller than or equal to a predetermined value, the control section may delete the data stored in the reception buffer corresponding to the predetermined communication interface.

In the information processing apparatus described above, the communication between the external device and the communication interface may be wireless communication.

In the information processing apparatus described above, if the control section determines that the one of the external devices, which is a communication destination of the predetermined communication interface, before the communication is broken is identical to one of the external devices after the communication is reconnected, the control section may request subsequent data to the data received before the communication disconnection from the external device.

In the information processing apparatus described above, the control section may determine whether or not the one of the external devices, which is a communication destination of the predetermined communication interface, before the communication is broken is identical to one of the external devices after the communication is reconnected, on the basis of identification information having been received from the external device and specified by the predetermined communication interface.

In the information processing apparatus described above, when data is being received from one of the external devices via a corresponding one of the predetermined communication interfaces, if communication between the one of the external devices and the corresponding predetermined communication interface is broken and then reconnected, the control section may request transmission of the identification information from the external device.

In the information processing apparatus described above, the data may be print data indicating print content, and the information processing apparatus may be a printer that executes print processing on the basis of the print data.

According to another aspect of the invention, there is provided a method of controlling an information processing apparatus including a plurality of communication interfaces capable of communicating with a plurality of respective external devices, the method including: when data is being received from one of the external devices via a corresponding one of the predetermined communication interfaces, if communication between the one of the external devices and the corresponding predetermined communication interface is broken and then reconnected, determining whether or not the one of the external devices, which is a communication destination of the predetermined communication interface, before the communication is broken is identical to one of the external devices after the communication is reconnected, and if determined to be identical, holding data stored in a reception buffer corresponding to the predetermined communication interface, whereas if determined not to be identical, deleting data stored in a reception buffer corresponding to the predetermined communication interface.

### BRIEF DESCRIPTION OF THE DRAWINGS

The invention will be described with reference to the accompanying drawings, wherein like numbers reference like elements.

FIG. 1 is a block diagram of a printer according to a first embodiment of the invention.

FIG. 2 is a flowchart illustrating the operation of a host device and the printer at the time of issuing a receipt.

FIG. 3 is a flowchart illustrating the operation of a host device and the printer at the time of establishing a communication connection between the host device and the printer.

FIGS. 4A and 4B are flowcharts illustrating the operation regarding communication between the host device and the printer.

FIGS. 5A and 5B are flowcharts illustrating the operation regarding communication between the host device and the printer.

### DESCRIPTION OF EXEMPLARY EMBODIMENTS

In the following, a description will be given of embodiments of the invention with reference to the drawings.

### First Embodiment

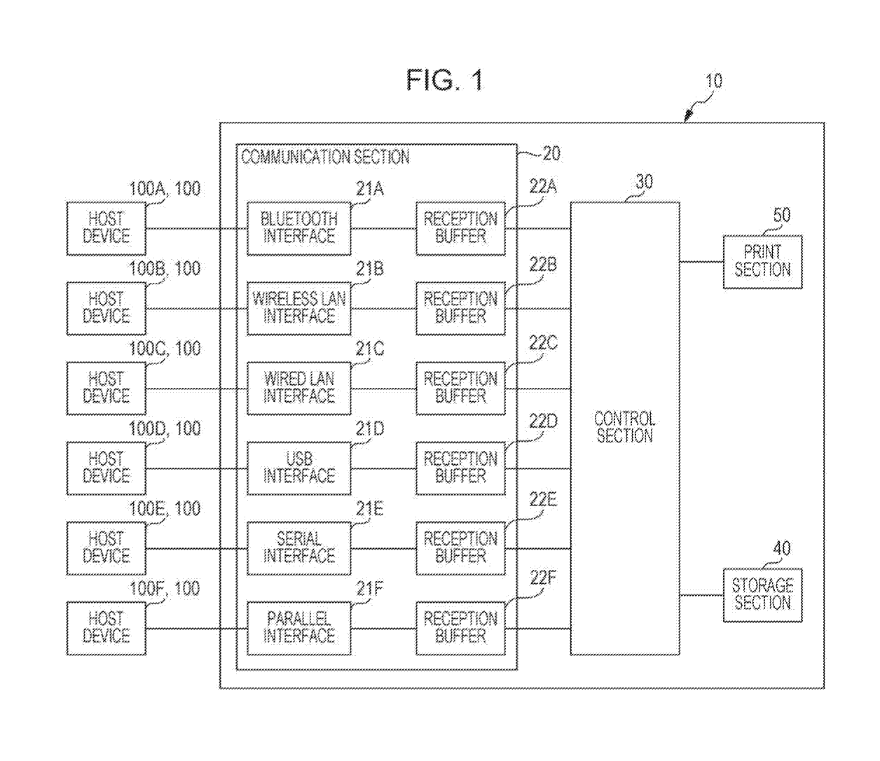

FIG. 1 is a block diagram of a printer 10 according to a first embodiment of the invention. The printer 10 is a thermal printer that prints an image on rolled paper, which is thermal paper. The printer 10 is capable of issuing a receipt under the control of the host device 100, which is an external device. In this regard, in this embodiment, the printer 10 is a thermal type printer. However, the printing method of the printer 10 is not limited to a thermal type, and may be another printing method, such as an ink jet type method, or the like.

The host device 100 is disposed on a registration counter of a store, such as a retail store, a restaurant, or the like, and is a computer that transmits print data for printing a receipt, or the like on the printer 10 and controls the printer 10. For example, the host device 100 is a POS terminal that communicates receipt information with a POS server, or the like, which is not illustrated in FIG. 1. The receipt information includes both accounting information on accounting and non-accounting information, such as a store logo, and the like.

As illustrated in FIG. 1, the printer 10 includes a communication section 20, a control section 30, a storage section 40, and a print section 50. The communication section 20 is a device for communicating with the host device 100 and includes a Bluetooth interface 21A, a wireless LAN interface 21B, a wired LAN interface 21C, a USB interface 21D, a serial interface 21E, and a parallel interface 21F as communication interfaces. Here, the Bluetooth interface 21A and the wireless LAN interface 21B are wireless communication interfaces, and the remaining communication interfaces are wired communication interfaces.

The Bluetooth interface 21A includes a communication module and a communication antenna that support Bluetooth (registered trademark) and executes wireless communication processing in accordance with the Bluetooth communication protocol under the control of the control section 30. Consequently, it becomes possible to communicate with a host device 100 (denoted by a reference sign 100A) capable of wireless communication by Bluetooth.

The wireless LAN interface 21B includes a communication module and a communication antenna that support a wireless LAN, such as Wi-Fi (registered trademark) or the like, and executes wireless communication processing in accordance with the communication protocol of the wireless LAN under the control of the control section 30. Thereby, it becomes possible to communicate with a host device 100 (denoted by a reference sign 100B) capable of wireless communication by the wireless LAN.

In the case of wireless LAN, the communication between the host device 100B and the printer 10 is normally performed via an access point not illustrated in FIG. 1. In this regard, by setting the communication mode between the host device 100B and the printer 10 to an ad-hoc mode in which both devices do not use an access point, it is also possible for the host device 100B and the printer 10 to directly perform communication.

The wired LAN interface 21C includes a communication module and a wired LAN port that correspond to a wired LAN, such as Ethernet (registered trademark), or the like. The wired LAN interface 21C executes communication processing with a host device 100 (denoted by a reference sign 100C) connected to the wired LAN port in accordance with the communication protocol of the wired LAN under the control of the control section 30. Thereby, it becomes possible to communicate with the host device 100C capable of communication by a wired LAN.

The USB interface 21D includes a communication module and a USB port that correspond to USB (registered trademark). The USB interface 21D executes communication processing with a host device 100 (denoted by a reference sign 100D) connected to the USB port in accordance with the USB communication protocol under the control of the control section 30. Thereby, it becomes possible to communicate with a host device 100D capable of communication by USB.

The serial interface 21E includes a communication module and a serial port that correspond to serial communication, such as RS-232C, or the like. The serial interface 21E executes communication processing with a host device 100 (denoted by a reference sign 100E) connected to the serial port in accordance with the communication protocol of serial communication under the control of the control section 30. Thereby, it becomes possible to communicate with a host device 100E capable of serial communication.

The parallel interface 21F includes a communication module and a parallel port for parallel communication, such as IEEE1284, or the like. The parallel interface 21F executes communication processing with a host device 100 (denoted by a reference sign 100F) connected to the parallel port in accordance with the communication protocol of parallel communication under the control of the control section 30. Thereby, it becomes possible to communicate with a host device 100F capable of parallel communication.

In this manner, the printer 10 is capable of communication with a host device 100 using any one of the communication interfaces 21A to 21F. That is to say, the printer 10 is capable of communication with a host device 100 in accordance with a communication protocol specified by the communication standard of each of the communication interfaces 21A to 21F. Accordingly, a host device 100 with which the printer 10 can communicate is not limited, and for example, it becomes possible for the printer 10 to move among different stores and to issue a receipt under the control of the host device 100 at each store.

Further, by using a plurality of communication interfaces 21A to 21F, it is possible for the printer 10 to make communication connections with a plurality of host devices 100 at the same time. In this regard, any one of the communication interfaces 21A to 21F need not be disposed, and the number of communication interfaces may be changed.

The communication section 20 includes reception buffers 22A to 22F that store data that are received from the host devices 100 via the individual communication interfaces 21A to 21F, respectively. The reception buffers 22A to 22F are memories that are disposed correspondingly to the respective communication interfaces 21A to 21. The reception buffers 22A to 22F may be independent memories disposed for the respective communication interfaces 21A to 21F, or may have a configuration of dividing the storage area of one memory to the respective communication interfaces 21A to 21F. Also, a part of the storage section 40 may be used for a part of or all of the reception buffers 22A to 22F.

In the following, when it is not necessary to distinguish the individual communication interfaces 21A to 21F in particular, they are generically expressed as a communication interface 21. Also, when it is not necessary to distinguish the individual reception buffers 22A to 22F in particular, they are generically expressed as a reception buffer 22.

The control section 30 includes a processor that performs operation processing and peripheral circuits, and is formed of, for example, a microcomputer, a system-on-chip (SOC), a CPU, or the like. The control section 30 executes a control program stored in the storage section 40 so as to control each section of the printer 10, monitors the communication state with the host device 100, and performs control in accordance with the monitoring results.

The storage section 40 includes a nonvolatile memory and stores various kinds of data, such as a control program, and the like. In this regard, a storage device other than a nonvolatile memory may be used for the storage section 40.

The print section 50 includes a transport mechanism that transports rolled paper accommodated in the case of the printer 10, a printing mechanism that forms dots on the rolled paper by a thermal head in order to print an image, a cutting mechanism that cuts the rolled paper at a predetermined position, and the like. Under the control of the control section 30, the print section 50 prints an image on the rolled paper by using the printing mechanism while transporting the rolled paper by using the transport mechanism, cuts the rolled paper at a predetermined position by using the cutting mechanism, and issues a receipt.

The print section 50 functions as the processing execution section that performs print processing on the basis of the print data stored in the reception buffer 22 under the control of the control section 30.

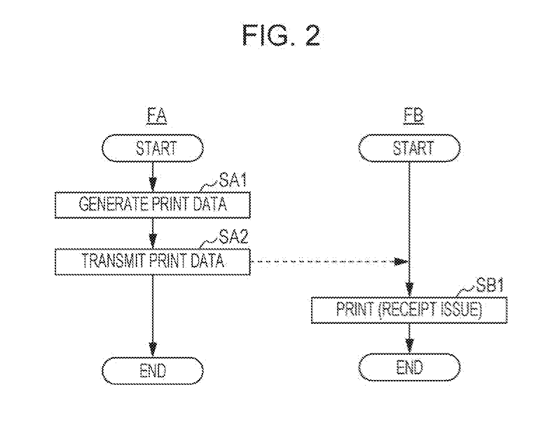

FIG. 2 is a flowchart illustrating the operation of the host device 100 and the printer 10 when a receipt is issued. A flowchart FA in FIG. 2 illustrates the operation of the host device 100, and a flowchart FB illustrates the operation of the printer 10. In this regard, in FIG. 2, it is assumed that the host device 100 is connected to any one of the communication interface 21 included in the printer 10, and is in a state capable of communication with the printer 10 in accordance with the corresponding protocol, and a communication disconnection will not occur.

As illustrated in the flowchart FA in FIG. 2, the host device 100 performs accounting processing (payment processing) in accordance with the accounting of a customer and generates print data on the basis of the accounting processing (step SA1). The print data is data instructing issue of a receipt on which receipt information is printed in accordance with a predetermined layout. The print data includes a plurality of control commands in accordance with the command system of the printer 10. Next, the host device 100 transmits the generated print data to the printer 10 (step SA2).

As illustrated in the flowchart FB in FIG. 2, the control section 30 of the printer 10 controls the communication section 20 and receives the print data transmitted by the host device 100 in step SA2 and controls the print section 50 to issue a receipt on the basis of the received print data (step SB1). In this case, the control section 30 and the communication section 20 operate together so that the received print data is stored in sequence in a reception buffer 22 corresponding to the communication interface 21 that has received the print data. The control section 30 then reads the print data stored in the reception buffer 22 and controls the print section 50 on the basis of the print data in order to issue a receipt.

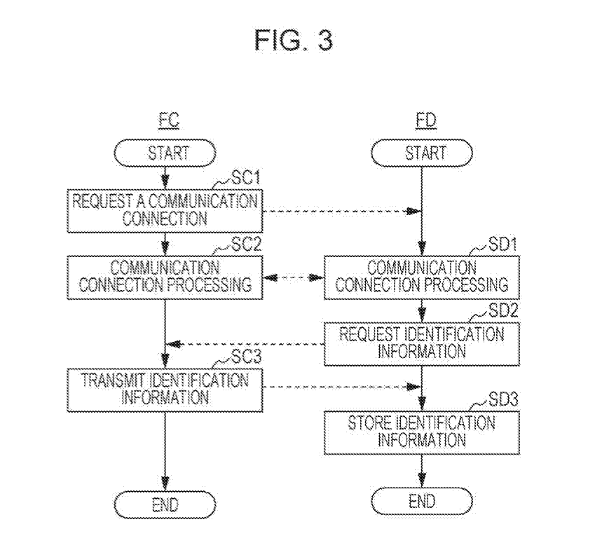

FIG. 3 is a flowchart illustrating the operation of the host device 100 and the printer 10 when the host device 100 and the printer 10 make a communication connection. A flowchart FC in FIG. 3 illustrates the operation of the host device 100, and a flowchart FD illustrates the operation of the printer 10. In this regard, the communication between the host device 100 and the printer 10 is performed via any one of the communication interfaces 21 included in the printer 10.

As illustrated in the flowchart FC in FIG. 3, the host device 100 transmits a communication connection request that requests a communication connection with the printer 10 to the printer 10 (step SC1). The communication connection request is a request that establishes a logical communication path between the host device 100 and the printer 10 and establishes a state capable of transmitting and receiving data between the host device 100 and the printer 10 in accordance with a communication protocol corresponding to the communication interface 21.

Next, the host device 100 and the printer 10 perform communication connection processing that establishes a communication connection in accordance with the communication connection request in step SC1 (steps SC2 and SD1). The communication connection processing is the communication processing that establishes a state capable of transmitting and receiving data between the host device 100 and the printer 10, and is the processing determined by the communication standard of the communication interface 21. Thereby, the host device 100 and the printer 10 establish a state capable of communication, that is to say, the host device 100 and the printer 10 make a communication connection.

As illustrated in the flowchart FC in FIG. 3, when the control section 30 of the printer 10 makes a communication connection with the host device 100, the control section 30 requests identification information that is identifiable information of the host device 100 from the host device 100, which is a communication destination (step SD2).

It is possible to apply any identifiable information of the host device 100 for the identification information. In this configuration, information specified by the communication interface 21 is used for the identification information, for example, a Bluetooth address, a MAC address, an IP address, a vendor ID, a product ID and a serial ID, and the like are used. In this regard, not only one of the above-described information may be used for the identification information, and a combination of two pieces of the above-described information may be used for the identification information.

When the host device 100 receives a request of identification information, the host device 100 reads predetermined information, such as a Bluetooth address, or the like and transmits the information to the printer 10 as the identification information (step SC3). The control section 30 of the printer 10 stores the received identification information in the storage section 40 (step SD3).

Here, a Bluetooth address is a specific address assigned to a device capable of Bluetooth communication, and a MAC address and an IP address are addresses assigned to a device capable of communication, such as Ethernet, or the like.

A vendor ID and a product ID are pieces of information assigned to a device corresponding to USB, a vendor ID is information issued for each vendor (business organization and company), and a product ID is information which is assigned to a device by the vendor. In this regard, either a vendor ID or a product ID might become common to a plurality of host devices 100. Accordingly, it is preferable to use a combination of a vendor ID and a product ID as identification information of the host device 100, or to use a combination of either one of a vendor ID or a product ID and the other information (IP address, or the like) as the identification information of the host device 100. In this manner, the information specified by the communication interface 21 is used for the identification information, and thus it is not necessary to separately provide special identification information.

For example, when the host device 100 and the printer 10 make a communication connection via the Bluetooth interface 21A, the printer 10 requests a Bluetooth address as the identification information. Thereby, it is possible to request information that is surely possessed by the host device 100 as the identification information, and thus it is not necessary to separately provide special identification information.

Also, a serial ID is a serial ID assigned to the host device 100 or a serial ID assigned to a device possessed by the host device 100. In this manner, it is possible to apply various kinds of information by which the host device 100 can be identified to the identification information.

Any one of information ought to be suitably set as the identification information.

Incidentally, the printer 10 includes a plurality of communication interfaces 21. In a state in which the host devices 100 are communicably connected with a plurality of respective communication interfaces 21, the control section 30 then determines one host device 100 connected to any one of the communication interfaces 21 out of the plurality of communication interfaces 21 to be a processing target.

“Determines one host device 100 to be a processing target” refers to the operation of receiving print data from the one host device 100 and determining the print data stored in the reception buffer 22 to be exclusively read and processed. While one host device 100 is processed, print data received from a host device 100 other than the one host device 100 is not read and is kept in a state of being stored in the reception buffer 22.

The reason why the control section 30 determines a host device 100 connected to one communication interface 21 to be a processing target is as follows. That is to say, if a plurality of host devices 100 are determined to be processing targets, the print data received from a plurality of host devices 100 are processed inconsistently, and thus a situation in which normal processing is not performed might occur. For example, when print data for issuing a receipt is received from one host device 100, in order to normally issue the receipt, it is necessary to execute the control commands included in the print data continuously in sequence. However, if a host device 100 other than the one host device 100 is determined to be a processing target almost at the same time with the one host device 100, during the execution of a control command included in the print data received from the one host device 100, a control command of the print data received from the other host device 100 might be executed.

When the host devices 100 are connected to a plurality of communication interfaces 21, the control section 30 of the printer 10 suitably changes the host devices 100 to be processed. For example, in a state in which data has not been received from any one of the host devices 100, when the control section 30 receives data from one of the host devices 100 and the received data is stored in the reception buffer 22, the control section 30 determines the one of the host devices 100 to be a processing target. If a predetermined period of time has elapsed after data received from the one of the host devices 100 was stored in the reception buffer 22, the control section 30 stops targeting the one of the host devices 100 to be processed.

After that, while the one of the host devices 100 is targeted for processing, if data has not been received from the other host devices 100, the control section 30 targets the host device 100 that has transmitted data next for processing. On the other hand, while the one of the host devices 100 is targeted for processing, if data has been received from the other one or a plurality of the host devices 100, the control section 30 targets the other host device 100 for processing in the order of data reception. The changing method of the host devices 100 targeted for processing may be carried out by a method other than the method described above.

The communication between the host device 100 and the printer 10 is sometimes disconnected due to unintentional influence, such as noise, or the like. In this embodiment, by performing the following processing, efficient communication between the host device 100 and the printer 10 is performed using the fact that there are a plurality of communication interfaces 21.

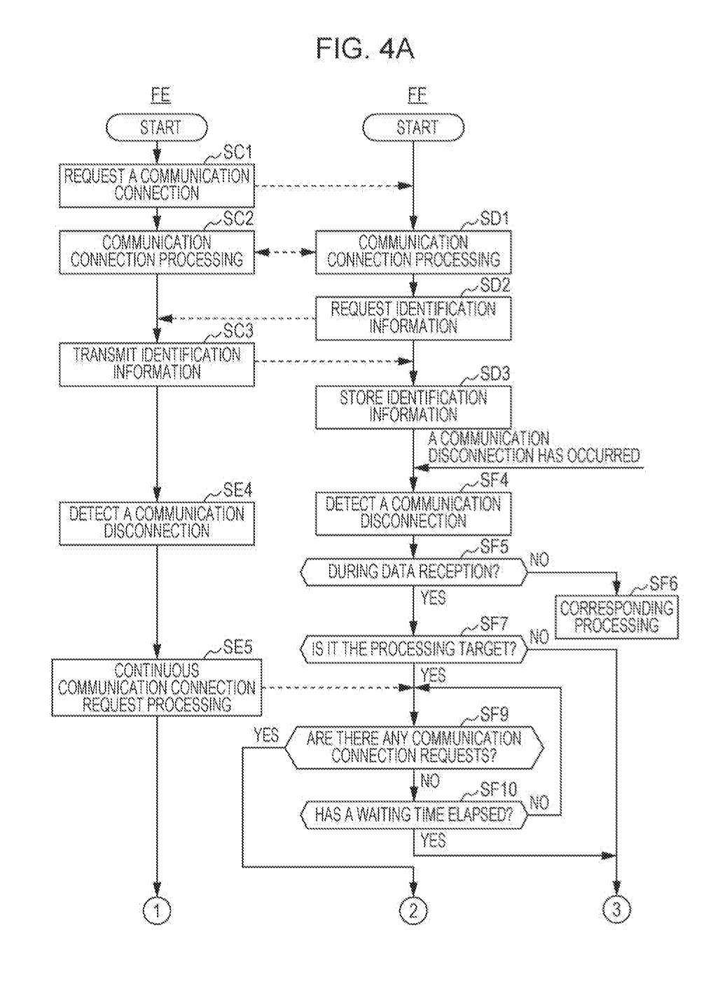

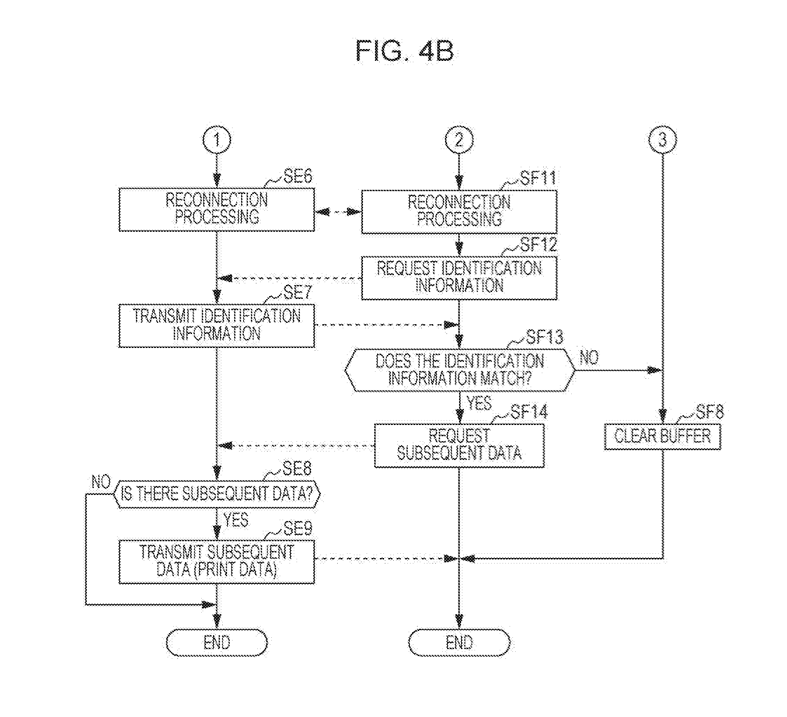

FIGS. 4A and 4B are flowcharts illustrating the operation regarding communication between the host device and the printer. Flowcharts FE in FIGS. 4A and 4B illustrate the operation of the host device 100, and flowcharts FF illustrate the operation of the printer 10. Also, in FIGS. 4A and 4B, the same symbol is given to the same processing as the processing illustrated in FIG. 3, and the duplicated description will be omitted.

Here, as illustrated in steps SC1, SC2, and SD1 in FIG. 4A, after the host device 100 and the printer 10 established a communication connection, the host device 100 performs the processing in step SA2 in FIG. 2, which transmits print data to the printer 10. Thereby, the control section 30 of the printer 10 receives data (print data) from the host device 100 via the communication interface 21. A state after the start of receiving the print data includes a state of not having received print data at all, and a state in which the subsequent print data has not been transmitted and thus the print data has not been received. The state after the start of receiving the print data is referred to as “when receiving data (print data) from the host device 100 via the communication interface 21” or “during reception of data (print data) from the host device 100” in a simplified manner.

Also, it is assumed that the host device 100 and the printer 10 periodically monitor whether or not a communication disconnection has occurred. FIG. 4A illustrates the case where a communication disconnection occurred after the storage processing (step SD3) of identification information received from the communication-destination host device 100 in the storage section 40.

As illustrated in the flowchart FF in FIG. 4A, when the control section 30 of the printer 10 detects a communication disconnection (step SF4), the control section 30 of the printer 10 determines whether or not data (print data) is being received from the host device 100 (step SF5). If not data is being received (step SF5: NO), the control section 30 of the printer 10 performs the corresponding processing (step SF6). The corresponding processing is, for example, waiting processing until a next communication connection request is received from the host device 100.

If data is being received (step SF5: NO), that is to say, while data (print data) is being received from the host device 100 via the communication interface 21, the control section 30 of the printer 10 determines whether or not the host device 100 that is the communication destination with which a communication disconnection has occurred is the processing-target host device 100 (step SF7).

If the communication destination with which a communication connection has occurred is not the processing-target host device 100 (step SF7: NO), the control section 30 performs the processing in step SF8. In step SF8, the control section 30 deletes the data (print data) stored in a reception buffer 22 corresponding to the communication interface 21 with which a communication disconnection occurs. In this case, the processing (hereinafter referred to as “reconnection corresponding processing”) in step SF9 to step SF14 will not be performed.

In this manner, if an unintended communication disconnection occurs with the host device 100 that is not the processing target, the control section 30 does not perform reconnection corresponding processing and deletes the data received from the host device 100 from the reception buffer 22. Thereby, the following effects are brought about.

That is to say, the data received from the processing-target host device 100 and stored in the corresponding reception buffer 22 is a target of execution by the control section 30 while the host device 100 is the processing target, and is processed in sequence. On the other hand, the data received from the host device 100 that is not the processing target and stored in the corresponding reception buffer 22 is not processed while the host device 100 is not the processing target and becomes the target of processing only after the host device 100 becomes the processing target. Accordingly, the rapidness is not requested from the host device 100 that is not the processing target in terms of completing all the data and completing processing based on the data as compared with the processing-target host device 100.

On the basis of this, in this configuration, if a communication disconnection occurs between a host device 100 that is not the processing target and the printer 10, reconnection corresponding processing is not performed and the data stored in the reception buffer 22 is deleted. Thereby, it is possible to prevent performing reconnection corresponding processing in a situation in which the rapidness is not requested for receiving and processing all the data, and thus it is possible to improve the processing efficiency. Also, by immediately deleting the reception buffer 22, it is possible to efficiently reduce an overflow of the reception buffer 22.

On the other hand, if the communication disconnection destination is the processing-target host device 100 (step SF7: YES), the control section 30 determines whether or not there has been a communication connection request (step SF9).

Here, as illustrated by the flowchart FE in FIG. 4A, when the host device 100 detects a communication disconnection (step SE4), the host device 100 performs continuous communication connection request processing in which a reconnection is requested (step SE5). The continuous communication connection request processing is the processing that repeatedly makes a communication connection request (also referred to as a reconnection request) in accordance with the communication standard of the communication interface 21. For example, the host device 100 transmits a reconnection request to the printer 10, which is the communication destination with which communication has been broken, at the time intervals and for the number of times that are determined in advance. If there are no responses from the printer 10 after an elapse of a certain time period, the host device 100 performs the processing for notifying a user of a communication error.

When the continuous communication connection request processing is performed, if the cause of the communication disconnection is not resolved, for example, when noise that inhibits predetermined communication has occurred, it is not possible for the control section 30 of the printer 10 to receive a communication connection request. In this case, the control section 30 determines that there are no communication connection requests (step SF9: NO), the control section 30 repeats the determination processing in step SF9 until a predetermined waiting time passes (step SF10: NO). When the predetermined waiting time elapses (step SF10: YES), the control section 30 performs the processing in step SF8.

Thereby, if a reconnection has not come from the host device 100 with which communication was broken for a predetermined time period regardless of whether or not the host device 100 is the processing target, the control section 30 deletes the data received from the host device 100 from the reception buffer 22. Accordingly, it is possible to prevent a situation in which the data that was received up to the middle is processed so that unnecessary print processing is performed. Also, the advantage of assuring the empty capacity of the reception buffer 22 is also obtained.

Here, if the cause of the communication disconnection between the host device 100 and the printer 10 has been resolved, the control section 30 of the printer 10 receives a communication connection request from the host device 100, and thus the control section 30 of the printer 10 performs reconnection processing for reconnecting with the host device 100 (step SF11). In this case, as illustrated in the flowchart FE in FIG. 4B, the host device 100 performs reconnection processing (step SE6), and thus reconnection processing in accordance with the communication standard is performed between the host device 100 and the printer 10. Here, the reconnection processing is processing for returning to the state before the communication between the host device 100 and the printer 10 is broken, that is to say, the communication connected state.

When the host device 100 and the printer 10 are reconnected (communication connected), as illustrated in the flowchart FF in FIG. 4B, the control section 30 of the printer 10 requests identification information from the host device 100, which is the communication destination (step SF12). In this case, the host device 100 reads predetermined information in accordance with the request of the identification information and transmits the information to the printer 10 as the identification information (step SE7). The identification information is the same identification information transmitted in step SC3.

When the control section 30 of the printer 10 receives the identification information from the host device 100, the control section 30 of the printer 10 determines whether or not the identification information that had been received before the communication disconnection and stored in the storage section 40 and the newly received identification information match (step SF13). That is to say, the control section 30 determines whether or not the communication-destination host device 100 before the communication disconnection and the communication-destination host device 100 after the communication reconnection match.

If they do not match (step SF13: NO), the control section 30 performs the processing in step SF8. Thereby, the control section 30 deletes the reception data (print data) stored in the reception buffer 22 corresponding to the reconnected communication interface 21. For example, if the processing-target host device 100 has changed before the communication disconnection and after the communication reconnection, step SF13 becomes a negation result, and the data received from the host device 100 before the communication disconnection is deleted from the reception buffer 22. Accordingly, the data received from the host device 100 to be processed at this point in time is stored in the reception buffer 22, and it becomes possible to promptly and suitably perform the processing based on the data. Also, by deleting the reception buffer 22, it is possible to effectively reduce the overflow of the reception buffer 22.

On the other hand, if the communication-destination host device 100 before the communication disconnection and the communication-destination host device 100 after the communication reconnection match (step SF13; YES), the control section 30 performs processing for requesting the subsequent data of the data transmitted before the communication disconnection from the host device 100 (step SF14). The processing in step SF14 is the processing for making a transmission request of the subsequent data of the data transmitted before the communication disconnection from the host device 100 and, for example, the processing for transmitting a predetermined command to the host device 100.

When the host device 100 receives the request (transmission request) of the subsequent data, the host device 100 performs determination processing for determining whether or not there is subsequent data to the data transmitted before the communication disconnection (step SE8). If determined that there is the subsequent data (step SE8; YES), the host device 100 transmits the subsequent data to the printer 10 (step SE9). For example, for the processing in steps SE8 and SE9, if it is possible for the host device 100 to identify to which control command has been transmitted out of the print data, the host device 100 determines whether or not there is subsequent data on the basis of the transmitted control command. If there is subsequent data, the host device 100 transmits the subsequent data. In place of this, for example, if it is possible for the host device 100 to detect untransmitted data by referring to the communication buffer, not illustrated in FIG. 1, for temporarily storing the communication data, the host device 100 determines whether or not there is detected untransmitted data, and transmits the untransmitted data. The processing in steps SE8 and SE9 is not limited to the above-described processing, and it is possible to widely apply publicly known processing.

If the subsequent data is transmitted to the printer 10 in this manner, in the printer 10, the reception data before the communication disconnection and the subsequent data, which is the reception data after the reconnection, is stored in the reception buffer 22 corresponding to the communication interface 21 with which the communication disconnection has occurred. In this case, the control section 30 of the printer 10 accesses the reception buffer 22 that stores data from the processing-target host device 100 and executes the reception data before the communication disconnection and after the reconnection, which were received in the reception buffer 22 in sequence so as to issue a receipt.

Thereby, compared with the case of retransmitting all the data from the processing-target host device 100 from the beginning after a communication disconnection, it is possible to reduce the total amount of communication between the host device 100 and the printer 10, and thus to efficiently perform communication.

In this regard, if there is no subsequent data, the reconnected host device 100 does not transmit data to the printer 10. That is to say, when the host device 100 has completed transmission of the print data before a communication disconnection, data is not transmitted after a reconnection. In this case, the control section 30 of the printer 10 performs processing on the basis of the reception data stored in the reception buffer 22. For example, the control section 30 performs the processing in step SF14 and then after an elapse of a predetermined waiting time, the control section 30 controls the print section 50 on the basis of the reception data before the communication disconnection, which is stored in the reception buffer 22. Thereby, it is possible to rapidly process the data from the processing-target host device 100.

As described above, the printer 10 according to this embodiment includes a plurality of communication interfaces 21 capable of communicating with the respective host devices 100, which are a plurality of external devices, and the control section 30 that monitors the communication state with the host device 100 and performs control in accordance with the monitoring results. While the control section 30 is receiving data via a predetermined communication interface 21 with which the processing-target host device 100 is communication connected, if the communication between the predetermined communication interface 21 and the processing-target host device 100 is broken and then is reconnected, the control section 30 performs the following processing.

The control section 30 determines whether or not the host device 100, which is the communication destination of the predetermined communication interface 21, before the communication disconnection, is identical to the host device 100 after the communication reconnection. If the control section 30 determines as identical, the control section 30 holds the data stored in a reception buffer 22 corresponding to the predetermined communication interface 21. On the other hand, if the control section 30 determines as not identical, the control section 30 deletes the data stored in a reception buffer 22 corresponding to the predetermined communication interface 21.

With the configuration and the control method, if the communication is restarted after a communication disconnection with the processing-target host device 100, reception data remains in a reception buffer 22 corresponding to the communication interface 21 used for the communication, and thus it becomes unnecessary for the processing-target host device 100 to retransmit all the data. On the other hand, if the communication is restarted with a different host device 100 after the communication disconnection, the data received from the previous communication destination is deleted from the reception buffer 22. Thereby, it is possible to reduce the amount of communication with the processing-target host device 100 via the communication interface 21 using the configuration including a plurality of communication interfaces 21, and thus to perform efficient communication. By performing efficient communication with the processing-target host device 100, it becomes possible to rapidly terminate the processing based on the data from the processing-target host device 100 and to rapidly change to the next processing target, and the like.

Also, the print section 50 functions the processing execution section that performs print processing on the basis of the data received from the processing-target host device 100. Also, when the reception buffer 22 corresponding to the communication interface 21 with which the communication with the host device 100 is broken is not the processing target of the print section 50, which is the processing execution section, the control section 30 deletes the data stored in the reception buffer 22. Thereby, the data that is relatively not required rapidity is deleted from the reception buffer 22, and thus it is possible to reduce the overflow of the reception buffer 22.

Also, the communication between the host device 100 and the communication interface 21 includes wireless communication. In wireless communication, in general, a communication disconnection is liable to occur relatively compared with wired communication. In this configuration, even if a communication disconnection occurs frequently, it is possible to reduce the amount of communication via the communication interface 21 that communicates with the processing-target host device 100, and to perform efficient communication.

Also, if the control section 30 determines that the processing-target host device 100 is identical before the communication disconnection and after the communication reconnection, the control section 30 requests the subsequent data to the data received before the communication disconnection from the host device 100. Thereby, the host device 100 responds to the request so as to start the processing for identifying the subsequent data of the data received before the communication disconnection.

Also, in this configuration, the control section 30 determines whether or not the communication-destination host device 100 of the communication interface 21 is identical before the communication disconnection and after the communication reconnection on the basis of the identification information specified by the communication interface 21. Thereby, it is not necessary to separately provide special identification information. Further, out of identification information defined by each of the communication interfaces 21, when identification information specified by the predetermined communication interface 21 is used for matching the host device 100, the following advantage is obtained. That is to say, for example, for a host device 100 capable of communication by wireless LAN, but incapable of Bluetooth communication, it is possible to avoid the situation of requesting a Bluetooth address that is not assigned to the host device 100 as identification information. Thereby, it becomes possible to reliably communicate using the identification information.

Also, the data received from the host device 100 is print data indicating print contents, and it is possible to prevent unnecessary data processing due to the print data up to the middle, that is to say, unnecessary print processing.

### Second Embodiment

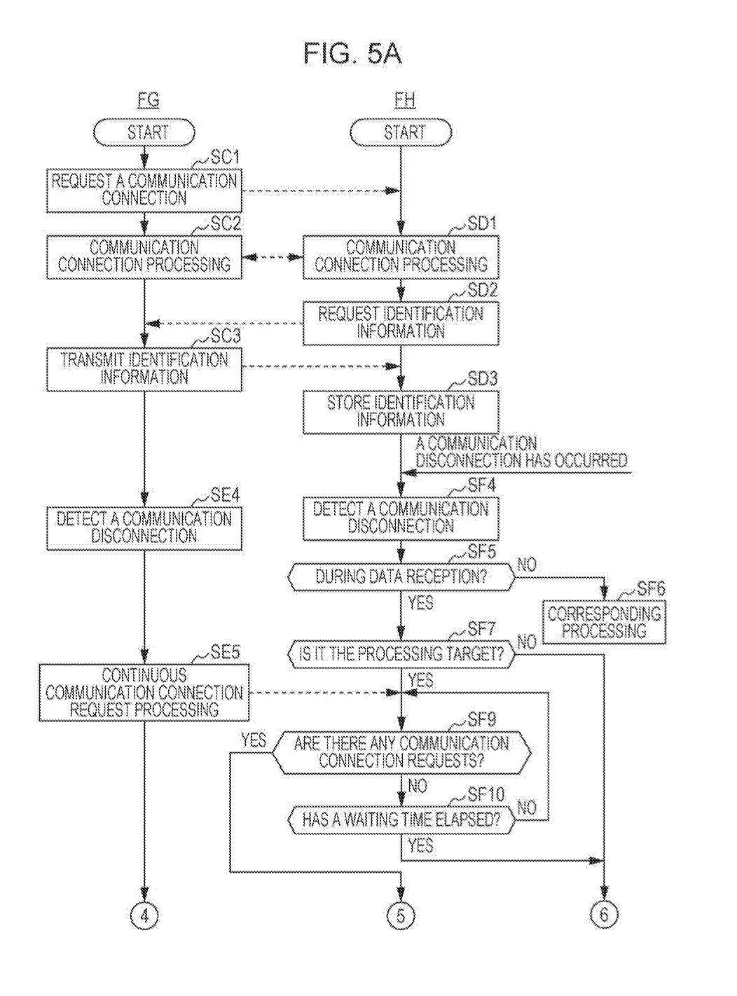

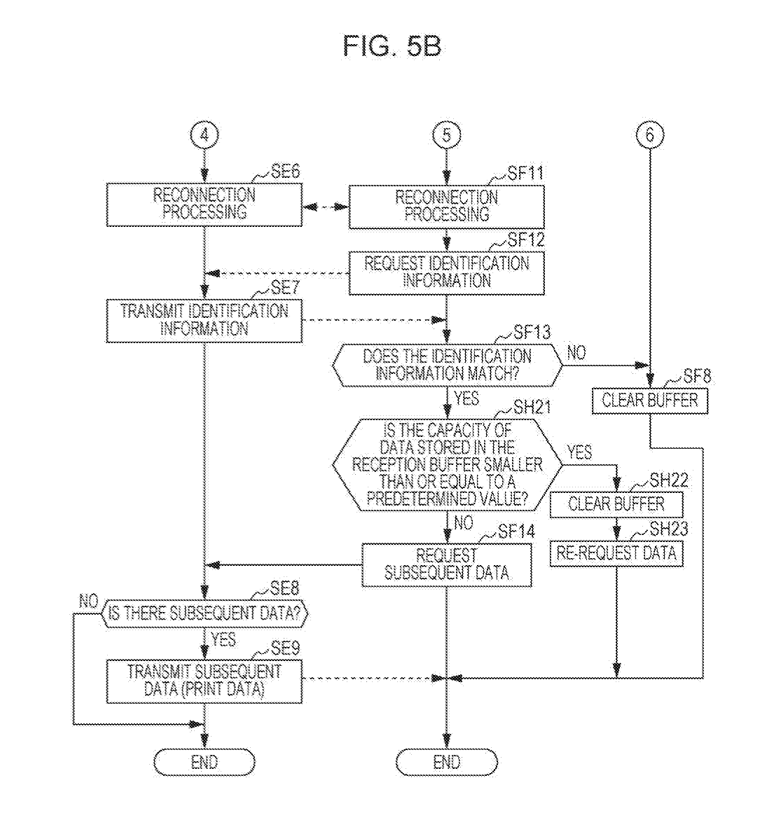

FIGS. 5A and 5B are flowcharts illustrating the operation regarding communication between the host device and the printer. Flowcharts FG in FIGS. 5A and 5B illustrate the operation of the host device 100, and flowcharts FH illustrate the operation of the printer 10. Also, the same symbol is given to the same processing as the processing in the first embodiment, and the duplicated description will be omitted.

As illustrated in FIGS. 5A and 5B, a second embodiment is different from the first embodiment in the point that after step SF13 illustrated in FIG. 4B, the processing of steps SH21, SH22, and SH23 are added.

In step SH21, the control section 30 accesses the reception buffer 22 that stores the reception data from the processing-target host device 100 and determines whether or not the capacity of the reception data stored in the reception buffer 22 is smaller or equal to a predetermined value. If the capacity of the reception data is larger than the predetermined value (step SH21: NO), the control section 30 proceeds to the processing in step SF14. Thereby, the processing for requesting the subsequent data of the data transmitted before the communication disconnection is performed in the same manner as the first embodiment.

On the other hand, if the capacity of the reception data is smaller than or equal to the predetermined value reception data (step SH21: YES), the control section 30 deletes the reception data stored in the reception buffer 22 (step SH22) and performs the processing in step SH23. In step SH23, the control section 30 re-requests data from the processing-target host device 100 (reconnected host device 100). Re-requesting data is requesting retransmission of data and is, for example, processing for transmitting a predetermined command indicating data re-request to the host device 100. Thereby, the host device 100 that has received the data re-request retransmits all the data to the printer 10.

That is to say, if the remaining amount of data received until the communication disconnection is larger than a predetermined value, the processing proceeds to step SF14 and the subsequent data of the data received before the communication disconnection is requested. On the other hand, if the remaining amount of data received until the communication disconnection is smaller or equal to a predetermined value, the data stored in the reception buffer 22 is deleted and retransmission of all the data is requested.

Thereby, if the remaining amount of data is large, the data is used and thus the time required for obtaining all the data is efficiently shortened, and only if the time shortening effect is relatively small, all the data is retransmitted. In this manner, when a communication disconnection occurs, it is possible to shorten communication time required until all the data is obtained from the processing-target host device 100. Accordingly, it is possible to perform efficient communication with the processing-target host device 100, and thus it becomes possible to rapidly terminate the processing based on the data from the processing-target host device 100 and to promptly change to the next processing target, or the like.

Each embodiment described above indicates one mode of the invention, and modifications and applications may be made within the scope of the invention.

For example, in each embodiment described above, the case of the printer 10 that issues a receipt has been described. However, the invention may be applied to a device that prints an object other than a receipt and a device having a function of print function, such as a copying machine, or the like.

Also, the invention may be applied to a device other than the printer 10 or a device having a print function. That is to say, it is possible to widely apply the invention to an information processing apparatus that includes a plurality of communication interfaces 21 and a processing execution section that performs processing on the basis of the reception data stored in the reception buffer 22.

As an example, it is possible to apply the invention to a display device including an image display section that displays an image on the basis of the image data obtained by communication. In particular, when image data is a large capacity data, such as a moving image, or the like, if a request of retransmission is made of a large capacity data, a delay occurs in displaying. However, by applying the invention, it is possible to obtain the advantage of reducing retransmission, and the like.

Also, it is possible to realize each block illustrated in FIG. 1 by cooperation of hardware and software, and thus each block does not indicate a specific hardware configuration.

What is claimed is:

1. An information processing apparatus including a plurality of communication interfaces capable of communicating with respective external devices, the information processing apparatus comprising:
reception buffers that correspond to the respective communication interfaces and store data received from the respective external devices; and
a control section that monitors communication states with the external devices and performs control in accordance with monitoring results,
wherein while data is being received from one of the external devices via a corresponding one of the predetermined communication interfaces, if communication between the one of the external devices and the corresponding predetermined communication interface is broken and then reconnected, the control section determines whether or not the one of the external devices, which is a communication destination of the predetermined communication interface, before the communication is broken, is identical to one of the external devices after the communication is reconnected, and
if determined to be identical, the control section holds data stored in a reception buffer corresponding to the predetermined communication interface,
whereas if determined not to be identical, the control section deletes data stored in a reception buffer corresponding to the predetermined communication interface.

2. The information processing apparatus according to claim 1, further comprising:
a processing execution section that executes processing on the basis of data stored in the reception buffer of a processing target,
wherein if the reception buffer corresponding to the communication interface with which the communication of the external device is broken is not the processing target of the processing execution section, the control section deletes the data stored in the reception buffer.

3. The information processing apparatus according to claim 1,
wherein when data is being received from one of the external devices via a corresponding one of the predetermined communication interfaces, if communication between the one of the external devices and the corresponding predetermined communication interface is broken and then reconnected,
if an amount of data stored in the reception buffer corresponding to the predetermined communication interface is smaller than or equal to a predetermined value, the control section deletes the data stored in the reception buffer corresponding to the predetermined communication interface.

4. The information processing apparatus according to claim 1,
wherein the communication between the external device and the communication interface is wireless communication.

5. The information processing apparatus according to claim 1,
wherein if the control section determines that the one of the external devices, which is a communication destination of the predetermined communication interface, before the communication is broken is identical to one of the external devices after the communication is reconnected, the control section requests subsequent data to the data received before the communication disconnection from the external device.

6. The information processing apparatus according to claim 1,
wherein the control section determines whether or not the one of the external devices, which is a communication destination of the predetermined communication interface, before the communication is broken is identical to one of the external devices after the communication is reconnected, on the basis of identification information having been received from the external device and specified by the predetermined communication interface.

7. The information processing apparatus according to claim 6,
wherein when data is being received from one of the external devices via a corresponding one of the predetermined communication interfaces, if communication between the one of the external devices and the corresponding predetermined communication interface is broken and then reconnected, the control section requests transmission of the identification information from the external device.

8. The information processing apparatus according to claim 1,
wherein the data is print data indicating print content, and the information processing apparatus is a printer that executes print processing on the basis of the print data.

9. A method of controlling an information processing apparatus including a plurality of communication interfaces capable of communicating with a plurality of respective external devices, the method comprising:
when data is being received from one of the external devices via a corresponding one of the predetermined communication interfaces, if communication between the one of the external devices and the corresponding predetermined communication interface is broken and then reconnected,
determining whether or not the one of the external devices, which is a communication destination of the predetermined communication interface, before the communication is broken is identical to one of the external devices after the communication is reconnected, and
if determined to be identical, holding data stored in a reception buffer corresponding to the predetermined communication interface,
whereas if determined not to be identical, deleting data stored in a reception buffer corresponding to the predetermined communication interface.
